(19) United States
(12) Patent Application Publication
(10) Pub. No.: US 2009/0015398 A1
(43) Pub. Date: Jan. 15, 2009

(54) SYSTEM AND METHOD OF PROVIDING LOCATION INFORMATION OF CHECKED BAGGAGE

(75) Inventors: Kulvir S. BHOGAL, Fort Worth, TX (US); Gregory J. BOSS, American Fork, UT (US); Rick A. HAMILTON, II, Charlottesville, VA (US); Alexandre POLOZOFF, Bloomington, IL (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 11/777,509

(22) Filed: Jul. 13, 2007

(51) Int. Cl. G08B 1/00; G08B 13/14

(52) U.S. Cl. 340/539.13; 340/572.1

(57) ABSTRACT

A system and method for notifying an end user of a location of baggage is provided. The method includes providing a computer infrastructure being operable to maintain baggage information and contact information of the end user, read an RFID tag at predetermined locations, and send the location of the baggage to the end user based on the location of the RFID tag and the read baggage information. The RFID tag is encoded with the baggage information. The system comprises an RFID tag encoded with baggage information and at least one RFID reader configured to read the encoded baggage information as it travels past a predetermined location. The system further includes at least one transmitting device to transit a location of the baggage to an end user, as received from an RFID scanner.

### FIELD OF THE INVENTION

The invention generally relates to a system and method of providing baggage location information and, more particularly, to a system and method of providing location information of checked baggage using RFID and communication technologies.

### BACKGROUND OF THE INVENTION

Misplaced baggage, misrouted baggage, etc. costs the airline industry millions of dollars a year. For example, an airline using long standing industry standard methods for tracking of baggage can still misplace four bags out of every 1,000 carried, which costs approximately $100 million a year to recover and properly deliver such baggage to the appropriate passenger.

In recent years, technological advances have permitted airports and airlines, in particular, to track the location of baggage based on bar coded tags. These bar code tags are attached to the bag at the point of passenger check-in, and intermittent scans of these bags throughout the loading and unloading processes permit airports and their associated carriers to reduce the quantity of lost and misdirected baggage.

Even more technologically advanced systems are being tried by the airlines, for example, RFID technologies. For example, current trials are being conducted to test the efficacy of using RFID tracking systems to track baggage throughout the baggage travel cycle. In one known trial, for example, tag readers were located in several places throughout the airport infrastructure: at check-in counters, along conveyer belts leading to the areas where baggage handlers work, and at the entrance to airplane cargo holds. Even more recently, having completed trials that use radio frequency identification technology at six South Korean airports, South Korea's Asiana Airlines is proposing to extend its systems as a way to track and monitor its passengers' luggage throughout several South Korean airports. Expanding this tracking system is a huge expenditure in both investment and infrastructure; however, such an investment could save the airline industry millions of dollars a year.

Symbol® technologies is a manufacturer of RFID tags and scanners. (Symbol is a trademark of Symbol Technologies in at least the United States.) In trials for South Korea's Asiana Airlines, Symbol technologies implemented one or two Symbol AR400 readers (interrogators) placed on the baggage conveyors at each of several South Korean airports. The Symbol AR400 readers ensured that the Symbol Class 0+EPC UHF tag attached to baggage could be reliably read and tracked. According to Symbol, the trial showed that using an RFID system would improve the efficiency of its baggage tracking and monitoring systems by 20 percent compared with the existing bar code-based system.

Although RFID technologies can provide improvements over current tracking technologies, opportunities for improvement still exist, particularly given that the current technologies only track the baggage. For example, although a passenger may know that improvements have been made, and that the chances of lost baggage have decreased from years past, the passenger still does not know that the baggage has arrived safely until the customer has arrived at his or her destination.

Accordingly, there exists a need in the art to overcome the deficiencies and limitations described hereinabove.

### SUMMARY OF THE INVENTION

In a first aspect of the invention, a method comprises scanning baggage at one or more predetermined locations to obtain baggage information. The method further includes providing the baggage location to an end user, using the obtained baggage information.

In another aspect of the invention, a method for deploying an application for notifying an end user of baggage location is provided. The method includes providing a computer infrastructure operable to maintain baggage information and contact information of the end user, read an RFID tag at predetermined locations, and send the location of the baggage to the end user based on the location of the RFID tag and the baggage information. The RFID tag is encoded with the baggage information.

In another embodiment, a system comprises an RFID tag encoded with baggage information and at least one RFID reader configured to read the encoded baggage information as it travels past predetermined locations. The system further includes at least one transmitting device to transmit a location of the baggage to an end user, as received from the RFID scanner.

In still another aspect of the invention, a computer program product comprises a computer usable medium having readable program code embodied in the medium. The computer program product includes at least one component to provide the processes of the invention.

### BRIEF DESCRIPTION OF THE DRAWINGS

FIG. 1 shows an illustrative environment for implementing the steps in accordance with the invention;

FIG. 2 shows a block diagram of an embodiment in accordance with the invention; and

FIG. 3 is a flow chart of steps for implementing aspects of the invention.

### DETAILED DESCRIPTION OF EMBODIMENTS OF THE INVENTION

The invention generally relates to a system and method of providing baggage location information and, more particularly, to a system and method of providing location information of checked baggage using RFID and communication technologies. In embodiments, RFID technology is implemented to improve the transportation industry, and in particular bring convenience and peace-of-mind to passengers with checked baggage. For example, in implementation, RFID technology is implemented in conjunction with communication technology, such as text messaging (SMS), cellular or other services provided over the Internet, which is configured to inform the passenger of baggage location during the passenger's trip. At each step of the trip, the particular location information of the baggage can be provided to the passenger ensuring the passenger that the checked baggage has been successfully loaded and transported to the destination of the passenger.

The method and system of the invention can also be implemented to ensure that the proper baggage is placed in an aircraft hold, matched to a passenger on that aircraft. For apparent safety reasons, this latter embodiment may be implemented to thwart terrorist activity by ensuring baggage and passenger are matched to a same flight. The technology described herein may also be used to provide information which is used to reroute baggage that was improperly routed to a destination.

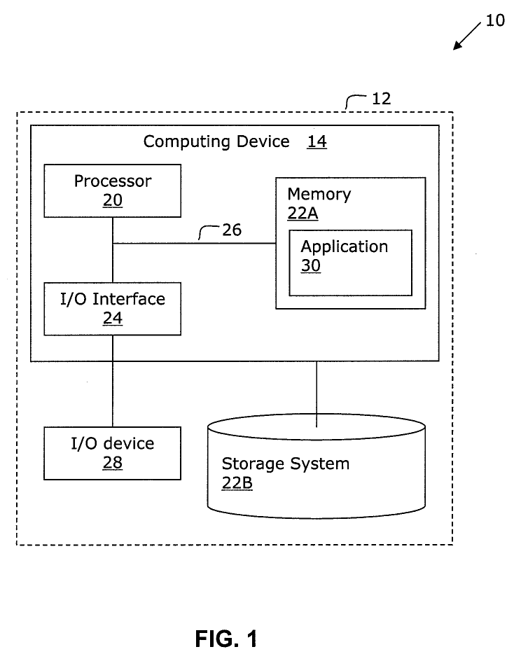

FIG. 1 shows an illustrative environment 10 for managing the processes in accordance with the invention. To this extent, the environment 10 includes a computer infrastructure 12 that can perform the processes described herein. In particular, the computer infrastructure 12 includes a computing device 14 that comprises a management system 30, which makes computing device 14 operable to track and then communicate luggage location to a passenger. The computing device 14 includes a processor 20, a memory 22A, an input/output (I/O) interface 24, and a bus 26. Further, the computing device 14 is in communication with an external I/O device/resource 28 and a storage system 22B.

As is known in the art, in general, the processor 20 executes computer program code, which is stored in memory 22A and/or storage system 22B. While executing computer program code, the processor 20 can read and/or write data to/from memory 22A, storage system 22B, and/or I/O interface 24. The bus 26 provides a communications link between each of the components in the computing device 14. The I/O device 28 can comprise any device that enables an individual to interact with the computing device 14 or any device that enables the computing device 14 to communicate with one or more other computing devices using any type of communications link.

The computing device 14 can comprise any general purpose computing article of manufacture capable of executing computer program code installed thereon (e.g., a personal computer, server, handheld device, etc.). However, it is understood that the computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a Client/Server) that communicate over any type of communications link, such as a network, a shared memory, or the like, to perform the process described herein. Further, while performing the process described herein, one or more computing devices in the computer infrastructure 12 can communicate with one or more other computing devices external to computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols. As discussed herein, the management system 30 enables the computer infrastructure 12 to track and then communicate luggage location to a passenger.

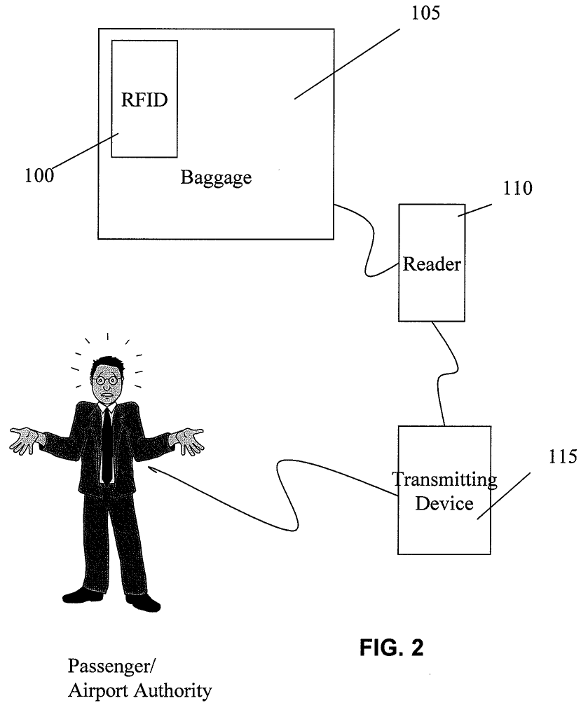

FIG. 2 shows a block diagram of a system in accordance with the present invention. As seen in FIG. 2, the system includes an RFID tag 100 on a piece of baggage or other article 105. An airline employee such as a ticket agent or gate personal may place the RFID tag 100 on the baggage 105. Alternatively, the owner of the bag or passenger may place the RFID tag 100 on the baggage 105. In one implementation, the RFID tag 100 is a Symbol Class 0+ EPC UHF tag.

One or more scanners (readers) 110 may be placed throughout the airport to track the location of the baggage. The readers may be, for example, Symbol AR400 readers which are designed to read the Symbol Class 0+ EPC UHF tag. The readers 110 may be placed in several locations including, for example, check-in counters, along conveyer belts leading to the areas where baggage handlers work, and at the entrance to or within airplane cargo holds. In further embodiments, the readers 110 may include logic which can reconcile the baggage information with the contact information, as can be implemented by those of skill in the art. This logic may be associated with the processing of FIG. 1. It should be understood that the tags and readers discussed herein are one illustrative example and that any known tag and reader combination is contemplated herein.

The system of the invention also includes transmitting devices 115 which are configured to provide (i.e., transmit) location information to the owner (passenger) of the baggage 105. The transmitting devices 115 may be, for example, cellular, WiFi or any known transmitting devices whether they be wireless or wired devices. In implementation, the transmitting devices 115 receive information from the reader 110 including the identification of the baggage, the destination of the baggage, the location of the baggage and the contact information, which allows the transmitting device to transmit the baggage location to the owner.

In alternate embodiments, the transmitting devices 115 may include logic which can reconcile the baggage information with the contact information, as can be implemented by those of skill in the art. This logic may be associated with the processing of FIG. 1. In this manner, the baggage location and information is sent to the transmitting devices 115 which, in turn, use this information to determine the proper contact information.

In embodiments, the transmitting devices 115 may provide information to airport or security officials such as the Transportation Security Authority (TSA). In this type of embodiment, the airport officials or TSA may be apprised of the location of suspicious baggage. This may include informing the TSA when baggage is loaded onto an aircraft without the passenger boarding the same aircraft.

In further embodiments, the airline employee or the passenger may encode the RFID tag 100, via well-known methodologies. This encoded information, as discussed herein, may include, owner name, unique personal identifier, one or more telephone numbers, home or business address, email address, etc.

In further embodiments, the infrastructure includes connection to a service provider, which may be the airline itself, or related company. The infrastructure may be the computer infrastructure as described in FIG. 1. In further embodiments, the invention provides a business method that performs the process steps of the invention on a subscription, advertising, and/or fee basis.

The service provider maintains the infrastructure such as that described in FIG. 1. The service provider, such as a Solution Integrator, could offer to perform the processes described herein. In this case, the service provider can create, maintain, and support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

In embodiments, the customer may elicit the services of the service provider to store the baggage and personal information of the owner such as, for example, type of baggage, destination of the baggage, contact information, etc. The airline employee may provide this same or similar information to the service provider. In either scenario, the RFID tag is encoded with the passenger information, as discussed above, which may include a preset numerical identifier on the RFID tag which is registered with the transportation or web service provider. This latter case means that the technologies for embedding personalized data into the tag need not exist within the home environment of the passenger. Rather, the information relating to a unique RFID tag could be entered on the Airlines website, for example.

Upon identification of the baggage, the transmitting device 115 may access the infrastructure of the service provider and provide the pertinent baggage and identification information to the service provider. In turn, the service provider, using the identification information, will access its database or other storage repository, and reconcile the identification information with the contact information of the owner (passenger) or, if appropriate with the airport or security officials. This may be performed using a simple hashing routine, for example. Once the contact information is known, the service provider will transmit a notification to the passenger, airport or security officials, as to the location of the baggage. In one implementation, this information can be used to reroute the baggage if the baggage is in the wrong location or being routed to the wrong location.

In further embodiments, the transmitting device 115 may be a transceiver. In such an embodiment, the service provider can provide the appropriate information back to the transceiver, which, in turn, will provide the location information to the passenger or airport or security officials.

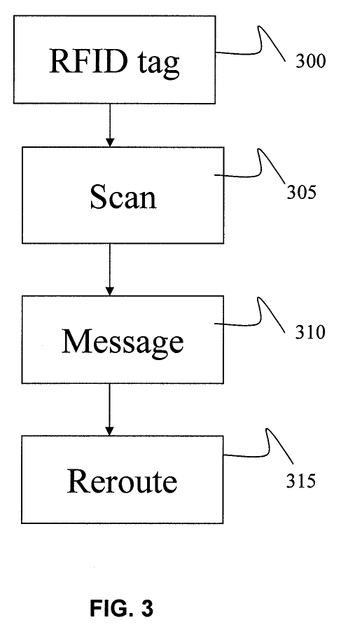

FIG. 3 is a flow diagram implementing steps of the invention which may be implemented in the environment of FIG. 1. FIG. 3 (and all other flow diagrams) equally represents a high-level block diagram of the invention. The steps of FIG. 3 (and all other flow diagrams) may be implemented and executed from either a server, in a client server relationship, or run on a user workstation. Additionally, the invention can take the form of an entirely hardware embodiment, an entirely software embodiment or an embodiment containing both hardware and software elements.

In an embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Referring back to FIG. 3, in step 300, each piece of baggage is fitted with an active or passive RFID tag, which can be encoded with several pieces of information, including owner name, unique personal identifier (e.g., type of baggage), one or more contact methodologies, e.g., cellular telephone numbers, SMS or email address, home or business address, etc. Once encoded with information, in step 305, the RFID readers will rapid scan the information at several critical points in transit so that unique information may be gathered, using existing and well-known technologies, including, for example,
(i) when the baggage is accepted by transit personnel and marked for a given flight/destination;
(ii) on the baggage conveyors, at one or more locations;
(iii) when the baggage is loaded onto the aircraft;
(iv) when the baggage is unloaded from the aircraft; and/or
(v) when the baggage is placed into a queue for a specific luggage carousel.
   In embodiments, the location will be noted along with the transaction time.

In step 310, at each step or predetermined steps of this process, and upon the respective RFID scan, an SMS message may optionally be sent to the number specified on the RFID tag, in addition to or exclusive of airport personal or TSA. Examples of messages might include the time, date and location of the baggage, e.g.,
Msg to 434-555-0142:
Rick's blue suitbag has been accepted at 12:42 PM ET on Delta Flt 2244 from CHO to ATL.
Msg to 434-555-0142
Rick's blue suitbag has been loaded at 1:24 PM ET onto Delta Flt 2244 from CHO to ATL
Msg to 434-555-0142
Rick's blue suitbag has been unloaded at 2:40 PM ET from Delta Flt 2244 at ATL
Msg to 434-555-0142
Rick's blue suitbag has been placed onto luggage carousel 9, arriving from Delta Flt 2244 at ATL

In step 315, in the event that an SMS or other type of message is received indicating an incorrect flight or other incorrect routing the baggage, e.g., baggage loaded onto an aircraft bound for a destination which is not matched to the owner's destination, then the passenger could notify the appropriate personnel so as to initiate an immediate rerouting of the baggage. This would potentially shorten the length of time for proper retrieval of the baggage. Likewise, since the information may be provided to officials, the officials can reroute the baggage, or in the case of suspicious baggage, immediately notify the proper personnel of the location of the luggage and appropriate action that should be taken to ensure the safety of the flying public.

As thus should be understood, the receipt of such messages provides the passenger with feedback and knowledge that the passenger's baggage will in fact arrive at the desired location. Given the practical constraint that cell phones may be turned on within an aircraft up until the moment of leaving the gate, and that cell phones may be turned on after touch-down, this innovation has practical relevance as well.

While the invention has been described in terms of embodiments, those skilled in the art will recognize that the invention can be practiced with modifications and in the spirit and scope of the appended claims.

What is claimed is:

1. A method, comprising:
reading baggage at one or more predetermined locations to obtain baggage information; and
providing baggage location to an end user, using the obtained baggage information.

2. The method of claim 1, wherein the reading is based on RFID (radio frequency identification) technology.

3. The method of claim 1, wherein the end user is a passenger.

4. The method of claim 3, wherein the passenger is an owner of the baggage.

5. The method of claim 1, wherein the end user is a security official or airport official.

6. The method of claim 1, wherein the baggage information is at least one of owner name, unique personal identifier, and one or more contact information of the end user.

7. The method of claim 1, wherein the providing step comprises sending a text message to the end user.

8. The method of claim 1, wherein the providing step comprises sending an email or other notification type to the end user.

9. The method of claim 1, wherein the baggage information is encoded onto an RFID tag by an airline employee or owner of the baggage.

10. The method of claim 1, wherein the reading step comprises reading the encoded baggage information.

11. The method of claim 1, further comprising placing one or more readers, to read the baggage information, at the one or more predetermined locations.

12. The method of claim 11, wherein the one or more predetermined locations includes check-in counters, along conveyer belts, and at an entrance or within a cargo hold.

13. The method of claim 1, wherein the baggage information is downloaded to a service provider which provides the baggage location to the end user.

14. The method of claim 1, wherein a service provider at least one of creates, maintains and supports a computer infrastructure that performs the steps of claim 1.

15. The method of claim 14, wherein the service provider is an airline carrier or related company.

16. The method of claim 1, wherein the steps of claim 1 are provided on a subscription, advertising, and/or fee basis.

17. A method for deploying an application for notifying an end user of a location of baggage, comprising providing a computer infrastructure being operable to:
maintain baggage information and contact information of the end user;
read an RFID tag at predetermined locations, the RFID tag is encoded with the baggage information; and
send the location of the baggage to the end user based on the location of the RFID tag and the read baggage information.

18. The method of claim 17, wherein the end user is at least one of a passenger, a security official and airport official.

19. The method of claim 17, wherein the baggage information is at least a unique personal identifier.

20. The method of claim 17, wherein the computer infrastructure is operable to send a text message or email to the end user.

21. The method of claim 17, wherein the baggage information is encoded onto the RFID tag by an airline employee or owner of the baggage.

22. The method of claim 17, wherein the baggage information is downloaded to a service provider which provides the baggage location to the end user.

23. The method of claim 22, wherein the computer infrastructure is created, maintained and supported by the service provider.

24. The method of claim 23, wherein service provider is an airline carrier or related company.

25. A system, comprising:
an RFID tag encoded with baggage information;
at least one RFID reader configured to read the encoded baggage information as it travels past a predetermined location; and
at least one device to transmit a location of the baggage to an end user, as received from the RFID scanner.

26. The system of claim 25, wherein the device or the at least one RFID reader is configured to reconcile the baggage information with contact information.

27. The system of claim 25, wherein the end user is at least a passenger, a security official or airport official.

28. The system of claim 25, wherein the baggage information is at least one of owner name, unique personal identifier, and one or more contact information.

29. The system of claim 25, wherein the at least one device is configured to send a text message, an email or other notification type to the end user.

30. The system of claim 25, wherein the at least one device is more than two devices placed at one or more of: check-in counters, along conveyer belts, and at an entrance to airplane cargo hold.

31. The system of claim 25, further comprising a computer infrastructure to store contact information and reconcile the contact information with the baggage information.

32. A computer program product comprising a computer usable medium having readable program code embodied in the medium, the computer program product includes at least one component to:
maintain baggage information and contact information of the end user;
read an RFID tag at predetermined locations, the RFID tag is encoded with the baggage information; and
send the location of the baggage to the end user based on the location of the RFID tag and the read baggage information.
